(19) United States
(12) Patent Application Publication
(10) Pub. No.: US 2024/0331718 A1
(43) Pub. Date: Oct. 3, 2024

(54) SPEECH NOISE REDUCTION APPARATUS AND METHOD

(71) Applicant: Lanto Electronic Limited, Kunshan City (CN)

(72) Inventors: Hsin-Nan CHEN, Kunshan City (CN); Tsung-Pao HSU, Kunshan City (CN); Jung-Pin CHIEN, Kunshan City (CN); Yao-Chun TSAI, Kunshan City (CN)

(73) Assignee: Lanto Electronic Limited, Kunshan City (CN)

(21) Appl. No.: 18/583,126

(22) Filed: Feb. 21, 2024

(30) Foreign Application Priority Data
Mar. 30, 2023 (CN) 202310330993.8

(51) Int. Cl. G10L 21/0232; G01D 5/34

(52) U.S. Cl. CPC G10L 21/0232; G01D 5/34

(57) ABSTRACT

Embodiments of the present disclosure disclose a speech noise reduction apparatus and method. A first radio device receives first sound signals including speech signals and noise signals, a second radio device receives the noise signals, a sensor module determines a sensing signal to determine position information of the first radio device, and a speech processing module reduces noise from the first sound signals according to the position information of the first radio device and the noise signals to determine noise-reduced speech signals. Therefore, noise is reduced from a received speech, and clarity and comfort of the speech heard by a user are improved.

### CLAIM OF PRIORITY AND CROSS-REFERENCE TO RELATED APPLICATION(S)

This application claims the benefit of Chinese Patent Application No. 202310330993.8, filed on Mar. 30, 2023, which is incorporated herein by reference in its entirety.

### BACKGROUND OF THE DISCLOSURE

### 1. Field of the Disclosure

The present disclosure relates to the field of speech signal processing technologies, and particularly to a speech noise reduction apparatus and method.

### 2. Description of the Related Art

With the development of society and technology, the widespread application of speech communication devices makes people's work and life increasingly convenient. However, many speech communication devices receive noise during communication. The noise affects clarity and comfort of speech heard by users, and may also harm users' hearing.

### BRIEF DESCRIPTION OF THE DISCLOSURE

In view of this, embodiments of the present disclosure provide a speech noise reduction apparatus and method to reduce noise in speech received by a user and to improve clarity and comfort of the speech heard by the user.

In a first aspect, a speech noise reduction apparatus is provided, the apparatus including:
a first radio device, disposed near a speech output source to receive first sound signals, where the first sound signals comprise speech signals and noise signals, and a position of the first radio device changes within a certain range;
a second radio device, disposed at a fixed distance from the speech output source to receive the noise signals;
a sensor module, configured to determine a sensing signal to determine position information of the first radio device; and
a speech processing module, configured to reduce noise from the first sound signals according to the position information of the first radio device and the noise signals to generate second sound signals, where the second sound signals are noise-reduced speech signals.

In some embodiments, the apparatus further includes a pull rod and a sensing end, the first radio device is connected to the sensing end through the pull rod, and a position of the pull rod changes within a certain range to change positions of the sensing end and the first radio device.

In some embodiments, the sensing end is a touch element, the sensor module includes at least one touch sensor, and the sensor module is configured to determine the position information of the first radio device according to the sensing signal generated by a contact point between the touch element and the touch sensor.

In some embodiments, the sensing end is an optical sensor, the sensor module comprises at least one light source emitter, and the sensor module is configured to determine the position information of the first radio device according to the sensing signal generated by the optical sensor when receiving an optical signal emitted by the light source emitter.

In some embodiments, the speech processing module includes a control unit and a sound collection and processing unit, the control unit is configured to obtain the position information of the first radio device and transmit the position information to the sound collection and processing unit, and the sound collection and processing unit is configured to determine a corresponding noise reduction parameter according to the position information of the first radio device and reduce noise from the first sound signals according to the noise signals and the corresponding noise reduction parameter.

In some embodiments, the speech processing module is further configured to determine the corresponding noise reduction parameter according to a pre-determined matching relationship and the position information of the first radio device, where the matching relationship is used for representing a corresponding relationship between the position information and the noise reduction parameter.

In some embodiments, the speech processing module is further configured to configure the corresponding noise reduction parameter for the noise signals to determine third sound signals, reverse phases of the third sound signals and then add the third sound signals to the first sound signals to determine the noise-reduced second sound signals.

In some embodiments, the apparatus further includes a filter for filtering high-frequency signals from the second sound signals to obtain fourth sound signals.

In some embodiments, wherein the apparatus further comprises an electro-acoustic transducer connected to an output end of the filter to output the fourth sound signals in a form of sound.

In some embodiments, the apparatus further comprises a D/A converter and a plurality of A/D converters, the A/D converters are disposed between the first radio device and the speech processing module and between the second radio device and the speech processing module to convert the received first sound signals and noise signals from an analog quantity to a digital quantity respectively, and the D/A converter is connected to an output end of the speech processing module to convert the second sound signals from a digital quantity to an analog quantity.

In a second aspect, a speech noise reduction method is provided, the method including:
receiving, by a first radio device, first sound signals, where the first sound signals include speech signals and noise signals, and a position of the first radio device changes within a certain range;
receiving, by a second radio device, the noise signals;
determining position information of the first radio device by a sensing signal; and
reducing noise from the first sound signals according to the position information of the first radio device and the noise signals to determine second sound signals, where the second sound signals are noise-reduced speech signals.

In some embodiments, the determining position information of the first radio device includes:
obtaining, by a sensor module, the sensing signal to determine the position information of the first radio device.

In some embodiments, the reducing noise from the first sound signals according to the position information of the first radio device and the noise signals to generate second sound signals is specifically:
configuring a corresponding noise reduction parameter for the noise signals to determine third sound signals; and
reversing phases of the third sound signals and then adding the third sound signals to the first sound signals to generate the second sound signals.

In some embodiments, the method further includes:
filtering high-frequency signals from the second sound signals to obtain fourth sound signals.

In a third aspect, a computer-readable storage medium is provided, where the computer-readable storage medium stores a computer program, and when the computer program is executed by a processor, the apparatus described in the first aspect is implemented.

### BRIEF DESCRIPTION OF THE DRAWINGS

The foregoing and other objectives, features and advantages of the present disclosure will become more apparent from the following description of embodiments of the present disclosure with reference to the accompanying drawings.

FIG. 1 is a schematic diagram of a speech noise reduction apparatus according to an embodiment of the present disclosure;

FIG. 2 is a schematic structural diagram of a speech noise reduction apparatus according to an embodiment of the present disclosure;

FIG. 3 is a schematic structural diagram of a speech noise reduction apparatus according to another embodiment of the present disclosure;

FIG. 4 is a schematic diagram of a position of a pull rod in the speech noise reduction apparatus according to an embodiment of the present disclosure;

FIG. 5 is a schematic structural diagram of a speech noise reduction apparatus according to still another embodiment of the present disclosure;

FIG. 6 is a schematic structural diagram of a speech noise reduction apparatus according to yet another embodiment of the present disclosure;

FIG. 7 is a schematic diagram of a signal processing process of the speech noise reduction apparatus according to an embodiment of the present disclosure; and

FIG. 8 is a flowchart of a speech noise reduction method according to an embodiment of the present disclosure.

### DETAILED DESCRIPTION OF EMBODIMENTS OF THE DISCLOSURE

The present disclosure is described below based on embodiments, but the present disclosure is not only limited to these embodiments. In the following detailed description of the present disclosure, some specific details are described in detail. The present disclosure can also be fully understood by those skilled in the art without the description of these details. In order to avoid confusing the substance of the present disclosure, well-known methods, processes, flows, elements and circuits are not described in detail.

In addition, it should be understood by those of ordinary skill in the art that the drawings provided herein are for illustrative purposes, and the drawings are not necessarily drawn to scale.

Meanwhile, it should be understood that in the following description, “circuit” refers to a conductive loop constituted by at least one element or sub-circuit through an electrical connection or an electromagnetic connection. When an element or circuit is referred to as being “connected to” another element or an element/circuit is referred to as being “connected” between two nodes, it may be directly coupled or connected to another element or there may be intermediate elements, and the connection between the elements may be physical, logical, or a combination thereof. On the contrary, when an element is referred to as being “directly coupled to” or “directly connected to” another element, it means that there is no intermediate element between the two elements.

Unless the context clearly requires otherwise, similar words such as “including” and “containing” throughout the application document should be interpreted as inclusive rather than exclusive or exhaustive; that is to say, it means “including but not limited to”.

In the description of the disclosure, it should be understood that the terms “first” and “second” are only used for descriptive purposes, and cannot be understood as indicating or implying relative importance. In addition, in the description of the disclosure, unless otherwise stated, “plurality” means two or more.

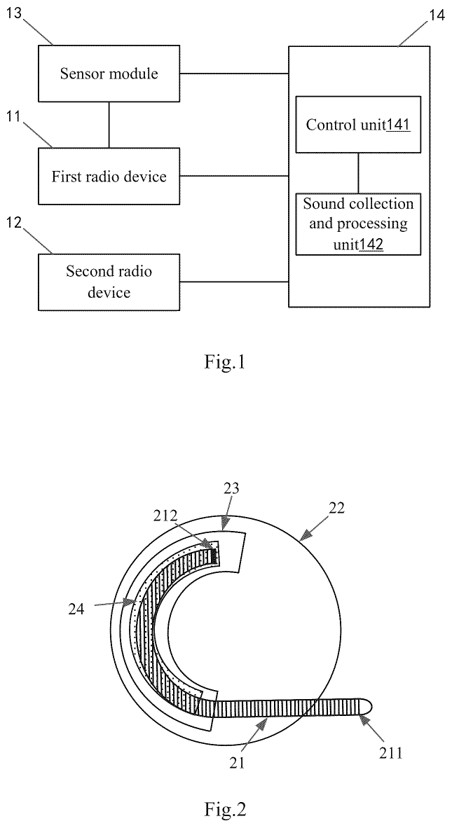

FIG. 1 is a schematic diagram of a speech noise reduction apparatus according to an embodiment of the present disclosure. In the embodiment shown in FIG. 1, the speech noise reduction apparatus includes a first radio device 11, a second radio device 12, a sensor module 13, and a speech processing module 14.

The first radio device 11 is disposed near a speech output source to receive first sound signals, the first sound signals include speech signals and noise signals, and a position of the first radio device changes within a certain range.

In some implementations, the first radio device may be an external microphone, which is disposed near the mouth of a person to receive speech signals (such as person's speech) and noise signals in an environment.

It should be understood that the first radio device may alternatively be other radio devices to receive speech signals and noise signals in the environment, which are not limited by the embodiments of the present disclosure.

The second radio device 12 is disposed at a fixed distance from the speech output source to receive the noise signals.

In some implementations, the second radio device may be an internal microphone, which may be disposed at a fixed distance from the mouth of the person to receive the noise signals in the environment. The second radio device at the fixed distance from the speech output source receives weak sound signals or almost does not receive sound signals, so signals received by the second radio device are almost the noise signals from the environment.

It should be understood that the second radio device may alternatively be other radio devices to receive noise signals in the environment, which are not limited by the embodiments of the present disclosure.

The sensor module 13 is configured to determine a sensing signal to determine position information of the first radio device.

A specific way of determining the sensing signal to determine the position information of the first radio device will be explained through the following embodiments.

In some implementations, the sensor module 13 includes at least one touch sensor. The touch sensor may be a capacitive touch sensor or other existing touch sensors, such as infrared touch sensors or resistive touch sensors, which are not limited by this embodiment. This embodiment will be described below accordingly with a capacitive sensor. The capacitive touch sensor uses a capacitance change generated by electrostatic bonding to detect coordinates of a touch position from induced current generated there. The induction principle is that voltage acts on four corners of an induction zone and forms a fixed electric field, the electric field may induce current when the induction zone is touched, the current is measured by a controller, and a contact point may be calculated according to different ratios of the current to the four corners. Accordingly, the position information of the first radio device may be determined by determining the contact point of the touch sensor.

The speech noise reduction apparatus of this embodiment may be applied to any device with radio function, such as a headphone, an amplification device, or a camera with a microphone.

In some optional implementations, the speech noise reduction apparatus of this embodiment further includes a pull rod and a sensing end, where a position relationship between the sensing end and the first radio device changes within a pre-determined range or changes according to a pre-determined rule, and the sensing end may determine its position by sensing the change of the pull rod and then determine a position of the first radio device according to its position relationship with the first radio device.

Optionally, the first radio device is connected to the sensing end through the pull rod. A position of the pull rod changes within a certain range to change positions of the sensing end and the first radio device.

Further optionally, the pull rod is controlled to slide or retract to change the positions of the sensing end and the first radio device. Further, the deformation of the pull rod is within a certain range or has a pre-determined rule to ensure that the relative position relationship between the sensing end and the first radio device changes within a certain range or has the pre-determined rule. Therefore, the position information of the first radio device may be determined by determining the position of the sensing end.

In this embodiment, a device where the speech noise reduction apparatus is located has a slide, and the pull rod slides inside the slide to change the positions of the sensing end and the first radio device. Because the slide is in a fixed shape and the deformation of the pull rod is within a certain range, the position change of the first radio device may be determined by the position change of the sensing end. It should be understood that this embodiment is not limited to this application scenario, and other forms of devices, such as a speech device with a retractable pull rod and a camera device with a foldable pull rod, may apply the speech noise reduction apparatus of this embodiment.

In some implementations, the sensor module 13 includes a touch sensor, and the sensing end is a touch element. As shown in the schematic structural diagram of the speech noise reduction apparatus in FIG. 2, the second radio device is disposed inside a shell 22, the first radio device 211 is connected to the touch element 212 through a pull rod 21, and the pull rod 21 may slide inside a slide 23, so as to change the positions of the touch element 212 and the first radio device 211. The touch element 212 and the first radio device 211 are located at two ends of the pull rod 21 respectively, and the pull rod 21 slides along the slide 23 in a fixed shaped, so when the pull rod 21 slides, the relative positions of the touch element 212 and the first radio device 211 change according to a certain rule. Therefore, this embodiment may determine the change rule of the relative positions of the touch element 212 and the first radio device 211 by testing, so as to further determine the position of the first radio device 211 according to the position of the touch element 212 and the obtained change rule of the relative positions. The touch sensor 24 is disposed inside the slide 23. When the pull rod 21 slides inside the slide 23, the contact point between the touch element 212 and the touch sensor 24 changes accordingly. When the touch element 212 is in contact with the touch sensor 24, a corresponding sensing signal is generated, and different sensing signals are generated when the contact points are different. That is, the generated sensing signal corresponds to the contact point. Therefore, the sensor module 13 may determine the position of the contact point according to the received sensing signal, that is, determine the position of the pull rod 21, so as to determine the position of the first radio device 211 at the other end of the pull rod 21.

In an optional implementation, after the touch element 212 is in contact with the touch sensor 24 to generate a sensing signal, the sensing signal is sent to the speech processing module 14, and the speech processing module 14 determines the position of the corresponding contact point according to the received sensing signal, that is, determines the position of the pull rod 21, so as to determine the position of the first radio device 211 at the other end of the pull rod 21.

In other implementations, the sensor module 13 includes a plurality of touch sensors, and the sensing end is a touch element. As shown in the schematic structural diagram of the speech noise reduction apparatus in FIG. 3, the second radio device is disposed inside a shell 32, the first radio device 311 is connected to the touch element 312 through a pull rod 31, and the pull rod 31 may slide inside a slide 33, so as to change the positions of the touch element 312 and the first radio device 311. The touch element 312 and the first radio device 311 are located at two ends of the pull rod 31 respectively, so when the pull rod 31 slides, the relative positions of the touch element 312 and the first radio device 311 change according to a certain rule. 5 touch sensors 341, 342, 343, 344, and 345 are disposed inside the slide 33. It should be understood that this embodiment does not limit a quantity of touch sensors, and the quantity may be increased or decreased according to actual situations. When the pull rod 31 slides within the slide 23, the touch element 312 is correspondingly in contact with the different touch sensors. When the touch element 312 is contact with each touch sensor, the touched touch sensor generates a corresponding sensing signal, and the touch sensors that are not currently in contact with the touch element 312 do not generate sensing signals, so the sensor module 13 may determine the touch sensor in contact with the touch element 312 according to the received sensing signal, so as to determine the position of the pull rod 31 and then determine the position of the first radio device 311.

In an optional implementation, after the touch element 312 is in contact with a touch sensor to generate a sensing signal, the sensing signal is sent to the speech processing module 14, and the speech processing module 14 determines the touch sensor in contact with the touch element 312 according to the received sensing signal, so as to determine the position of the pull rod 31 and then determine the position of the first radio device 311 at the other end of the pull rod 31.

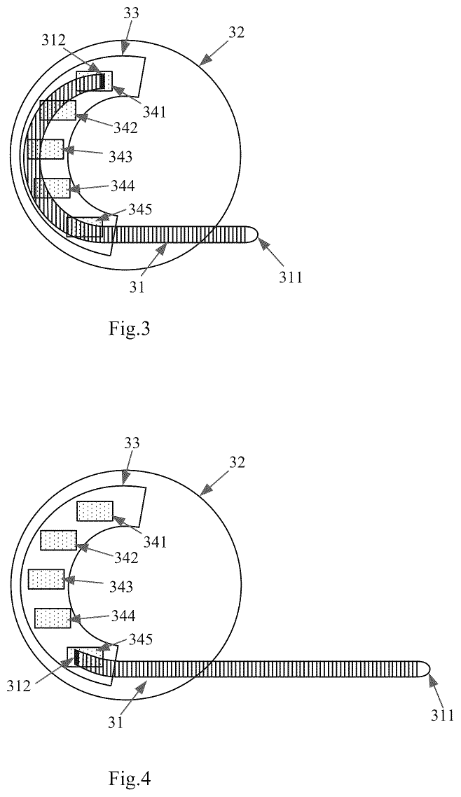

For example, when the pull rod 31 is located in the position shown in FIG. 3, the touch sensor 341 is in contact with the touch element 312 to determine that the first radio device 311 is closest to the second radio device inside the shell 32. When the pull rod 31 is located in the position shown in FIG. 4, the touch sensor 345 is in contact with the touch element 312 to determine that the first radio device 311 is farthest from the second radio device inside the shell 32.

In other implementations, the sensor module 13 includes at least one light source emitter. The light source emitter may be various existing light source emitters such as LED (Light Emitting Diode) and LD (Laser Diode), which are not limited by the embodiments of the present disclosure. LD emits infrared light, and the infrared light irradiates a surface of an object and is reflected. Because the speed of light is known, time of reflection from different depths of the object may be measured by an optical sensor (such as an infrared sensor), distances or depths of different positions of the object may be calculated by simple mathematical formulas, and the position information of the first radio device may be determined.

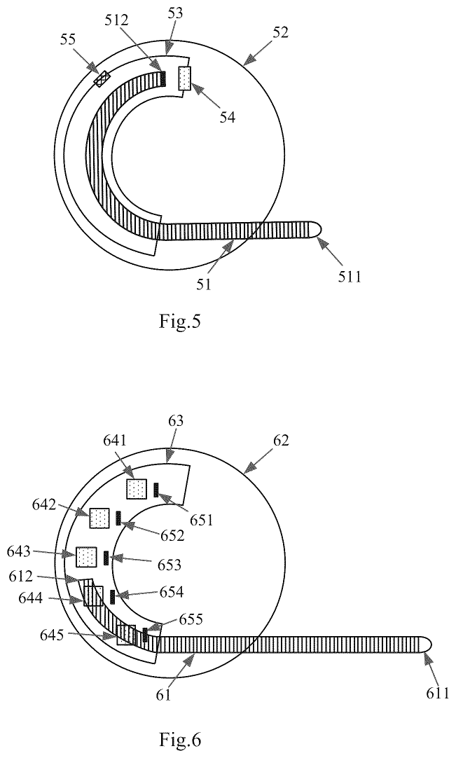

In some implementations, the sensor module 13 includes a light source emitter, and the sensing end is an optical sensor. As shown in the schematic structural diagram of the speech noise reduction apparatus in FIG. 5, the second radio device is disposed inside a shell 52, the first radio device 511 is connected to the optical sensor 512 through a pull rod 51, and the pull rod 51 may slide inside a slide 53, so as to change the positions of the optical sensor 512 and the first radio device 511. The optical sensor 512 and the first radio device 511 are located at two ends of the pull rod 51 respectively, so when the pull rod 51 slides, the relative positions of the optical sensor 512 and the first radio device 511 change according to a certain rule. The light source emitter 54 is disposed inside the slide 53 to emit optical signals. When the pull rod 51 slides inside the slide 53, the optical sensor 512 may generate a corresponding sensing signal according to a time difference of receiving the optical signals emitted by the light source emitter 54. In addition, when the time difference of receiving, by the optical sensor 512, the optical signals emitted by the light source emitter 54 is different, the generated sensing signal is different. That is, the generated sensing signal corresponds to the time difference of receiving, by the optical sensor 512, the optical signals emitted by the light source emitter 54. Because the time difference corresponds to the distance between the optical sensor 512 and the light source emitter 54, the sensing signal corresponds to the distance between the optical sensor 512 and the light source emitter 54. The sensor module 13 may determine the distance between the optical sensor 512 and the light source emitter 54 according to the received sensing signal. Because the position of the light source emitter 54 is fixed, the position of the optical sensor 512 may be determined, and then the position of the first radio device 511 may be determined according to the rule of the relative positions of the optical sensor 512 and the first radio device 511.

In an optional implementation, the optical sensor 512 may alternatively receive the optical signal emitted by the light source emitter 54, generate a sensing signal, and then send the sensing signal to the speech processing module 14, and the speech processing module 14 determines the distance between the optical sensor 512 and the light source emitter 54 according to the received sensing signal. Because the position of the light source emitter 54 is fixed, the position of the optical sensor 512 may be determined, and then the position of the first radio device 511 may be determined according to the rule of the relative positions of the optical sensor 512 and the first radio device 511.

It is easy to understand that, when the distance between the optical sensor 512 and the light source emitter 54 is closer, the time difference between emitting of an optical signal by the light source emitter 54 and receiving of the optical signal by the optical sensor 512 is shorter, indicating that the distance between the light source emitter 54 and the optical sensor 512 is closer, and correspondingly, the distance between the first radio device 511 and the second radio device inside the shell 52 is also closer.

In some implementations, a reflecting device 55 is further disposed inside the slide to reflect light when the pull rod 51 slides to the farthest distance from the light source emitter 54, so as to ensure that the optical sensor 512 may receive the optical signal emitted by the light source emitter 54.

In other implementations, the optical sensor may alternatively be disposed close to the light source emitter, and the position of the pull rod is calculated according to the difference between the time when the optical sensor receives the reflected optical signal and the time when the light source emitter emits the optical signal, so as to determine the position of the first radio device, where the reflected optical signal is an optical signal after the optical signal emitted by the light source emitter is reflected.

In some implementations, the sensor module 13 includes a plurality of light source emitters. As shown in FIG. 6, the second radio device is disposed inside a shell 62, and the pull rod 61 may slide within the slide 53 and drive the first radio device 611 to change its position. The light source emitters 641, 642, 643, 644, and 645 are disposed inside the slide 53, and corresponding optical sensors 651, 652, 653, 654, and 655 are disposed near the respective light source emitters to receive corresponding reflected optical signals. It should be understood that quantities of light source emitters and corresponding optical sensors are not limited to five, but may be increased or decreased according to actual situations. This embodiment does not limit this. When the pull rod 61 slides inside the slide 63, each optical sensor generates a corresponding sensing signal according to the time difference of receiving the optical signal emitted by the corresponding light source emitter. When the time difference of receiving, by each optical sensor, the optical signal emitted by the corresponding light source emitter is different, the generated sensing signal is different. Therefore, when the pull rod 61 slides to different positions inside the slide 63, the reception of the reflected optical signal by each optical sensor is different. For example, when an end 612 of the pull rod is located in a position shown in FIG. 6, the optical signals emitted by the light source emitters 644 and 645 are reflected when encountering the pull rod 61 as an obstacle, while the optical signals emitted by the light source emitters 641, 642, and 643 are reflected when encountering other obstacles (such as an inner wall of the slide). In this case, the time difference of receiving the corresponding reflected optical signals by the optical sensors 654 and 655 is small, while the time difference of receiving the reflected optical signals by the optical sensors 651, 652, and 653 is large. Therefore, the sensing signals generated by the optical sensors 654 and 655 are significantly different from those generated by the optical sensors 651, 652, and 653. Therefore, the sensor module 13 may determine a position of the end 612 of the pull rod 61 according to the sensing signal received by each optical sensor, for example, determine that the end 612 of the pull rod 61 in the foregoing example is located between the light source emitters 644 and 645, so as to determine the position of the first radio device 611 at the other end of the pull rod 61. In this case, the position of the pull rod may be determined according to the time difference of the optical signals received by the optical sensors, so as to determine the position of the first radio device.

In an optional implementation, after each optical sensor generates a sensing signal, the sensing signal is sent to the speech processing module 14, and the speech processing module 14 determines the position of the end 612 of the pull rod 61 according to the sensing signal received by each optical sensor, so as to determine the position of the first radio device 611 at the other end of the pull rod 61.

The disposal of the sensing end is related to the sliding or retraction of the pull rod and the device using the speech noise reduction apparatus. It should be understood that the sensing end is disposed to determine the position of the first radio device, for example, disposed at an expansion joint of the retractable pull rod or a foldable position of the foldable pull rod. This embodiment does not limit the disposal.

The speech processing module 14 is configured to reduce noise from the first sound signals according to the position information of the first radio device and the noise signals to generate second sound signals, where the second sound signals are noise-reduced speech signals.

In some implementations, the speech processing module 14 includes a control unit 141 and a sound collection and processing unit 142, where the control unit 141 is configured to obtain the position information of the first radio device and transmit the position information to the sound collection and processing unit 142, and the sound collection and processing unit 142 is configured to determine a corresponding noise reduction parameter according to the position information of the first radio device and reduce noise from the first sound signals according to the noise signals and the corresponding noise reduction parameter.

Further, the speech processing module 14 is configured to determine the corresponding noise reduction parameter according to a pre-determined matching relationship and the position information of the first radio device, where the matching relationship is used for representing a corresponding relationship between the position information and the noise reduction parameter.

In some implementations, noise reduction parameters corresponding to best speech effects are pre-determined by experiments when the first device is in different positions, and the position information of the first device is matched with the noise reduction parameters one to one, so as to determine the matching relationship between the positions of the first radio device and the noise reduction parameters.

Optionally, when the sensor module 13 includes a touch sensor and the sensing end is a touch element, as shown in FIG. 2, the configuration of the noise reduction parameter is related to the relative positions of the first radio device 211 and the second radio device. Specifically, when the first radio device 211 and the second radio device are closest, the corresponding noise reduction parameter is configured for the noise signals to minimize their gain, so as to ensure the strength of the noise-reduced speech signals. Specifically, when the first radio device 211 and the second radio device are farthest, the corresponding noise reduction parameter is configured for the noise signals to maximize their gain, so as to ensure the clarity of the noise-reduced speech signals. The second radio device is disposed inside the shell 22 and its position is fixed, while the position of the first radio device 211 changes with the sliding of the pull rod 21 to change the relative positions of the second radio device and the first radio device 211, so the change in the relative positions of the first radio device 211 and the second radio device actually depends on the change in the position of the first radio device 211, and the configuration of the noise parameter actually depends on the position of the first radio device 211. When the pull rod 21 slides, the relative position relationship between the touch element 212 and the first radio device 211 changes according to a certain rule. Therefore, the corresponding position of the first radio device 211 may be represented by the position of the touch element 212.

Specifically, a functional relationship of the noise reduction parameters corresponding to different contact points between the touch element 212 and the touch sensor 24 may be pre-determined by experiments. It is easy to understand that the position of the contact point corresponds to the position of the touch element 212 one to one. When the pull rod 21 slides, the corresponding noise reduction parameters are determined according to the contact points between the touch element 212 and the touch sensor 24 and the pre-determined functional relationship, so as to determine the corresponding noise reduction parameter corresponding to the current contact point. The position of the contact point corresponds to the position of the touch element 212 one to one, and the position of the touch element 212 may represent the corresponding position of the first radio device 211, so the matching relationship between the position of the first radio device 211 and the noise reduction parameter may be determined according to the corresponding relationship between the contact point and the noise reduction parameter.

Optionally, when the sensor module 13 includes a plurality of touch sensors and the sensing end is a touch element, as shown in FIG. 3, the configuration of the noise reduction parameter is related to the relative positions of the first radio device 311 and the second radio device, the second radio device is disposed inside the shell 32 and its position is fixed, while the position of the first radio device 311 changes with the sliding of the pull rod 31 to change the relative positions of the second radio device and the first radio device 311, so the change in the relative positions of the first radio device 311 and the second radio device actually depends on the change in the position of the first radio device 311, and the configuration of the noise parameter actually depends on the position of the first radio device 311. The relative position relationship between the touch element 312 and the first radio device 311 changes according to a certain rule, that is, the position of the touch element 312 corresponds to the position of the first radio device 311, so the position of the first radio device 311 may be represented by the position of the touch element 312.

Specifically, the noise reduction parameters corresponding to the best speech effects are pre-determined by experiments when the touch element 312 is in contact with the touch sensors 341, 342, 343, 344, and 345, respectively, so as to match the noise reduction parameters with the contacts with the touch sensors. It is easy to understand that the position of the touch element 312 may be determined correspondingly according to the contact with the touch sensor, so the noise reduction parameter may be determined according to the position of the touch element 312. Because the position of the touch element 312 may represent the position of the first radio device 311, the matching relationship between the position of the first radio device 311 and the noise reduction parameter may be determined according to the corresponding relationship between the touched touch sensor and the noise reduction parameter. For example, when the touch element 312 is in contact with the touch sensor 341 with the sliding of the pull rod 31, the first radio device is matched with the noise reduction parameter pre-configured for the touch sensor 341. When the touch element 312 is in contact with the touch sensor 345 with the sliding of the pull rod 31, the first radio device 311 is matched with the noise reduction parameter pre-configured for the touch sensor 345.

Therefore, the corresponding noise reduction parameter is configured according to the different position of the first radio device for the noise signals received by the second radio device, so as to determine third sound signals.

In some implementations, the third sound signals are subjected to phase reversal and then added to the first sound signals to cancel the noise signals among the first signals, so as to obtain noise-reduced sound signals and eliminate noise before the sound signals enter cars.

The configuration of the noise reduction parameter is related to the distance between the first radio device and the second radio device. When the first radio device and the second radio device are closest, the corresponding noise reduction parameter is configured for the noise signals to minimize their gain, and the third sound signals are subjected to phase reversal and added to the first sound signals, thereby reducing cancellation of the speech signals among the first sound signals and ensuring the strength of the noise-reduced speech signals. When the first radio device and the second radio device are farthest, the corresponding noise reduction parameter is configured for the noise signals to maximize their gain, and the third sound signals are subjected to phase reversal and added to the first sound signals, thereby canceling the noise signals among the first sound signals as much as possible and ensuring the clarity of the noise-reduced speech signals.

According to the embodiments of the present disclosure, the first radio device receives first sound signals including speech signals and noise signals, the second radio device receives the noise signals, the sensor module determines a sensing signal to determine position information of the first radio device, and the speech processing module reduces noise from the first sound signals according to the position information of the first radio device and the noise signals to determine noise-reduced speech signals. Therefore, noise is reduced from a received speech, and clarity and comfort of the speech heard by a user are improved.

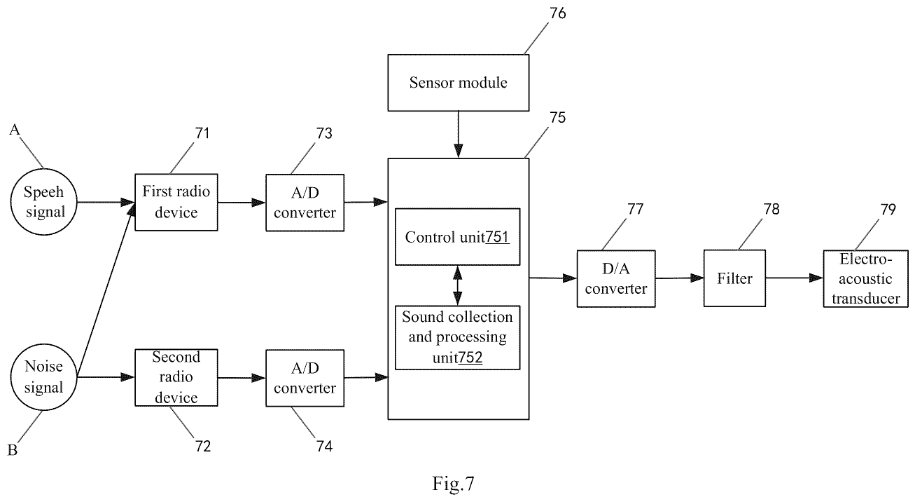

In some embodiments, the apparatus further includes a filter, an electro-acoustic transducer, an A/D converter, and a D/A converter to process the sound signals and the noise signals. Specifically, a signal processing process is shown in FIG. 7. A speech signal A and a noise signal B are input into the first radio device 71. Sound signals output by the first radio device 71 are converted from an analog quantity to a digital quantity by the A/D converter 73 and input into the speech processing module 75. The noise signal B is also input into the second radio device 72, and the noise signal output by the second radio device 72 is converted from an analog quantity to a digital quantity by the A/D converter 74 and input to the speech processing module 75.

In some implementations, the speech processing module 75 includes a control unit 751 and a sound collection and processing unit 752. The control unit 751 obtains position information of the first radio device 71 through the sensor module 76 when receiving the speech signal and transmits the position information to the sound collection and processing unit 752. The sound collection and processing unit 752 determines a corresponding noise reduction parameter according to the position information of the first radio device 71, configures a corresponding noise reduction parameter according to a different position of the first radio device 71 for the noise signal received by the second radio device 72, reverses a phase of the obtained signal, and outputs the signal together with the speech signal A and the noise signal B to cancel the noise signal. The D/A converter 77 converts the signals processed by the speech processing module 75 from a digital quantity to an analog quantity. The converted analog quantity signals are input into the filter 78 for filtering, so as to filter high-frequency signals and eliminate oscillations caused by phase reversal delay.

According to the embodiments of the present disclosure, the first radio device receives first sound signals including speech signals and noise signals, the second radio device receives the noise signals, the sensor module determines a sensing signal to determine position information of the first radio device, and the speech processing module reduces noise from the first sound signals according to the position information of the first radio device and the noise signals to determine noise-reduced speech signals. Therefore, noise is reduced from a received speech, and clarity and comfort of the speech heard by a user are improved.

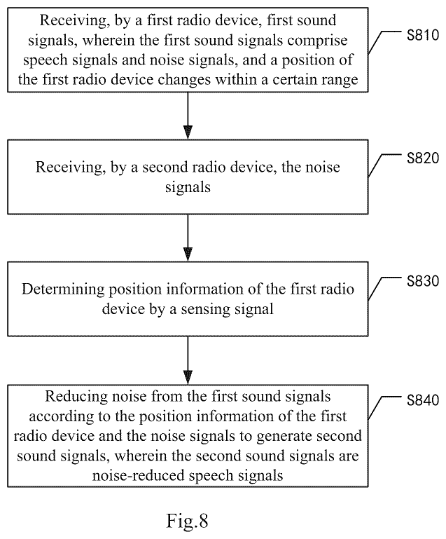

FIG. 8 is a flowchart of a speech noise reduction method according to an embodiment of the present disclosure. As shown in FIG. 8, the speech noise reduction method according to an embodiment of the present disclosure includes the following steps:

Step S810, receiving, by a first radio device, first sound signals, wherein the first sound signals comprise speech signals and noise signals, and a position of the first radio device changes within a certain range.

Step S820, receiving, by a second radio device, the noise signals.

Step S830, determining position information of the first radio device by a sensing signal.

In some embodiments, a sensor module obtains the sensing signal to determine the position information of the first radio device. Specifically, a way of determining the position information of the first radio device is the same as that in the foregoing embodiments, and will not be repeated here.

Step S840, reducing noise from the first sound signals according to the position information of the first radio device and the noise signals to generate second sound signals, wherein the second sound signals are noise-reduced speech signals.

Specifically, a corresponding noise reduction parameter is configured for the noise signals to determine third sound signals, and the third sound signals are subjected to phase reversal and then added to the first sound signals to determine the second sound signals.

In some implementations, high-frequency signals are filtered from the second sound signals to obtain fourth sound signals, and the fourth sound signals obtained by filtering are output, thereby improving clarity and comfort of sound entering cars.

According to the embodiments of the present disclosure, the first radio device receives first sound signals including speech signals and noise signals, the second radio device receives the noise signals, the sensor module determines a sensing signal to determine position information of the first radio device, and the speech processing module reduces noise from the first sound signals according to the position information of the first radio device and the noise signals to determine noise-reduced speech signals. Therefore, noise is reduced from a received speech, and clarity and comfort of the speech heard by a user are improved.

A person skilled in the art should understand that the embodiments of the present application may be provided as a method, an apparatus (device), or a computer program product. Therefore, the present application may adopt a form of an entirely hardware embodiment, an entirely software embodiment, or an embodiment combining software with hardware. Further, the present application may adopt a computer program product implemented on one or more computer-readable storage media (including, but not limited to a magnetic disk memory, a CD-ROM, an optical memory, etc.) including computer usable program code therein.

The present application is described with reference to flowcharts of the method, apparatus (device) and computer program product according to the embodiments of the present application. It should be understood that each procedure in the flowchart may be implemented by computer program instructions.

These computer program instructions may be stored in a computer-readable memory that may guide a computer or other programmable data processing devices to work in a specific manner, so that the instructions stored in the computer-readable memory produce an article of manufacture including an instruction apparatus, and the instruction apparatus implements specified functions in one process or more procedures of the flowchart.

The computer program instructions may also be provided to a general-purpose computer, a special-purpose computer, an embedded processor, or a processor of other programmable data processing devices to generate a machine, so that an apparatus for implementing specified functions in one or more procedures of the flowchart is generated by instructions executed by the computer or the processor of other programmable data processing devices.

Another embodiment of the present disclosure relates to a non-volatile storage medium, which is used for storing a computer-readable program, where the computer-readable program is used for assisting a computer to perform some or all of the method embodiments described above.

That is, those skilled in the art may understand that all or some of the steps in the method for implementing the foregoing embodiments may be accomplished by specifying relevant hardware through a program. The program is stored in a storage medium and includes several instructions to enable a device (which may be a single chip, a chip, etc.) or a processor to perform all or some of the steps of the methods in the embodiments of the present application. The foregoing storage medium includes various media that may store program code, such as a USB flash drive, a mobile hard disk, a read-only memory (ROM), a random access memory (RAM), a magnetic disk, or an optical disc.

The above descriptions are only the preferred embodiments of the present disclosure and are not intended to limit the present disclosure, and various alterations and changes may be made in the present disclosure for those skilled in the art. Any modification, equivalent replacement, improvement, and the like made within the spirit and principle of the present disclosure should fall within the protection scope of the present disclosure.

I/We claim:

1. A speech noise reduction apparatus, the apparatus comprising:
a first radio device, disposed near a speech output source to receive first sound signals, wherein the first sound signals comprise speech signals and noise signals, and a position of the first radio device changes within a certain range;
a second radio device, disposed at a fixed distance from the speech output source to receive the noise signals;
a sensor module, configured to determine a sensing signal to determine position information of the first radio device; and
a speech processing module, configured to reduce noise from the first sound signals according to the position information of the first radio device and the noise signals to generate second sound signals, wherein the second sound signals are noise-reduced speech signals.

2. The apparatus according to claim 1, wherein the apparatus further comprises a pull rod and a sensing end, the first radio device is connected to the sensing end through the pull rod, and a position of the pull rod changes within a certain range to change positions of the sensing end and the first radio device.

3. The apparatus according to claim 2, wherein the sensing end is a touch element, the sensor module comprises at least one touch sensor, and the sensor module is configured to determine the position information of the first radio device according to the sensing signal generated by a contact point between the touch element and the touch sensor.

4. The apparatus according to claim 2, wherein the sensing end is an optical sensor, the sensor module comprises at least one light source emitter, and the sensor module is configured to determine the position information of the first radio device according to the sensing signal generated by the optical sensor when receiving an optical signal emitted by the light source emitter.

5. The apparatus according to claim 1, wherein the speech processing module comprises a control unit and a sound collection and processing unit, the control unit is configured to obtain the position information of the first radio device and transmit the position information to the sound collection and processing unit, and the sound collection and processing unit is configured to determine a corresponding noise reduction parameter according to the position information of the first radio device and reduce noise from the first sound signals according to the noise signals and the corresponding noise reduction parameter.

6. The apparatus according to claim 1, wherein the speech processing module is further configured to determine the corresponding noise reduction parameter according to a pre-determined matching relationship and the position information of the first radio device, wherein the matching relationship is used for representing a corresponding relationship between the position information and the noise reduction parameter.

7. The apparatus according to claim 1, wherein the speech processing module is further configured to configure the corresponding noise reduction parameter for the noise signals to determine third sound signals, reverse phases of the third sound signals and then add the third sound signals to the first sound signals to determine the noise-reduced second sound signals.

8. The apparatus according to claim 1, wherein the apparatus further comprises a filter for filtering high-frequency signals from the second sound signals to obtain fourth sound signals.

9. The apparatus according to claim 8, wherein the apparatus further comprises an electro-acoustic transducer connected to an output end of the filter to output the fourth sound signals in a form of sound.

10. The apparatus according to claim 1, wherein the apparatus further comprises a D/A converter and a plurality of A/D converters, the A/D converters are disposed between the first radio device and the speech processing module and between the second radio device and the speech processing module to convert the received first sound signals and noise signals from an analog quantity to a digital quantity respectively, and the D/A converter is connected to an output end of the speech processing module to convert the second sound signals from a digital quantity to an analog quantity.

11. A speech noise reduction method, the method comprising:
receiving, by a first radio device, first sound signals, wherein the first sound signals comprise speech signals and noise signals, and a position of the first radio device changes within a certain range;
receiving, by a second radio device, the noise signals;
determining position information of the first radio device by a sensing signal; and
reducing noise from the first sound signals according to the position information of the first radio device and the noise signals to generate second sound signals, wherein the second sound signals are noise-reduced speech signals.

12. The method according to claim 11, wherein the determining position information of the first radio device comprises:
obtaining, by a sensor module, the sensing signal to determine the position information of the first radio device.

13. The method according to claim 11, wherein the reducing noise from the first sound signals according to the position information of the first radio device and the noise signals to generate second sound signals is specifically:
configuring a corresponding noise reduction parameter for the noise signals to determine third sound signals; and
reversing phases of the third sound signals and then adding the third sound signals to the first sound signals to generate the second sound signals.

14. The method according to claim 11, wherein the method further comprises:
filtering high-frequency signals from the second sound signals to obtain fourth sound signals.
